(19) United States
(12) Patent Application Publication
(10) Pub. No.: US 2023/0186421 A1
(43) Pub. Date: Jun. 15, 2023

(54) DEVICES, METHODS, AND COMPUTER READABLE MEDIA FOR SCREEN-CAPTURE COMMUNICATION

(71) Applicant: HUAWEI TECHNOLOGIES CO., LTD., SHENZHEN (CN)

(72) Inventors: Thomas Daniel WALLACE, Kanata (CA); Parth BHATT, Kitchener (CA); Mustafa MOHAMAD, Kitchener (CA); Ahmed ABDELKHALEK, Kitchener (CA)

(73) Assignee: HUAWEI TECHNOLOGIES CO., LTD., SHENZHEN (CN)

(21) Appl. No.: 17/546,149

(22) Filed: Dec. 9, 2021

(51) Int. Cl. G06T 1/00; H04N 21/8358; H04N 21/2389

(52) U.S. Cl. CPC G06T 1/0085; H04N 21/8358; G06T 1/0092; H04N 21/23892; H04L 63/0485; G06T 2201/0051; G06T 2201/0065

(57) ABSTRACT

The present disclosure provides for methods, apparatus and computer readable media related to screen-capture communication based on invisible watermark. An aspect of the disclosure provides for a method including inserting one or more templates into one or more frames of a video for correcting frame perspective of the one or more frames captured by a device. The method further includes writing a message into the one or more frames of the video and displaying the video. According to a second aspect, a second method is provided. The second method includes capturing one or more frames of a video displayed on a device comprising a hidden message. The method further includes locating one or more templates and correcting frame perspective of the captured frames based on the templates. The method further includes extracting the message from the one or more frames of the video.

### CROSS-REFERENCE TO RELATED APPLICATIONS

This is the first application filed for the present disclosure.

### FIELD OF THE DISCLOSURE

The present disclosure pertains to the field of device-to-device communication, and in particular to systems and methods for screen-capture communication.

### BACKGROUND

Screen capture communication may refer to a device-to-device communication via a screen and a camera. Existing screen-capture implementations include optical character recognition (OCR), barcodes, and more recently quick response (QR) codes. However, existing screen-capture implementations have one or more limitations including: obtrusive communication, limited message size, and device-to-device synchronization challenges. Obtrusive communication may be relevant for applications in which visual appeal is important. Limited message size and synchronization challenges may go hand in hand. Existing screen-capture implementations may only have the ability to communicate a limited message size, and in the case of a larger message, existing implementations may be inadequate to ensure complete transmission and retrieval of the larger message.

Therefore, there is a need for systems and methods for screen-capture communication that obviates or mitigates one or more limitations of the prior art.

This background information is provided to reveal information believed by the applicant to be of possible relevance to the present disclosure. No admission is necessarily intended, nor should be construed, that any of the preceding information constitutes prior art against the present disclosure.

### SUMMARY

The present disclosure provides for methods, systems and apparatus related to screen-capture communication based on invisible watermark. According to a first aspect, a method is provided. The method includes inserting one or more templates into one or more frames of a video for correcting frame perspective of the one or more frames captured by a device. The method further includes writing a message into the one or more frames of the video. Template may refer to one or more identified or inserted objects in one or more frames of a video that may be used for correcting a perspective distortion, for example via template matching as described herein. The method further includes displaying the video comprising the message that is hidden. The method may provide for transmitting a hidden message between two devices.

In some embodiments, the method further includes dividing the message into a plurality of message segments. In some embodiments, the method further includes packetizing each message segment with control information. The method may provide for transmitted hidden messages that cannot be transmitted in a single image or frame.

In some embodiments, the writing a message into the one or more frames of the video includes writing each packetized message segment into a different respective frame of the video.

In some embodiments, the writing each packetized message segment into a different respective frame of the video includes converting each frame of the video from spatial domain to frequency domain. In some embodiments, the writing each packetized message segment into a different respective frame of the video further includes writing each packetized message segment into the frequency domain of a different respective frame of the video. In some embodiments, the writing each packetized message segment into a different respective frame of the video further includes converting each frame of the video from the frequency domain back to the spatial domain. The method may provide for hiding a message in an image while maintaining image appearance.

In some embodiments, the writing each packetized message segment into the frequency domain of a different respective frame of the video includes selecting, from the frequency domain, frequency components for modulations. In some embodiments, the writing each packetized message segment into the frequency domain of a different respective frame of the video further includes modulating the selected frequency components to write in the frequency domain the said packetized message segment.

In some embodiments, the writing a message into the one or more frames of the video includes converting the one or more frames from spatial domain to frequency domain. In some embodiments, the writing a message into the one or more frames of the video further includes writing the message into the frequency domain of each of the one or more frames. In some embodiments, the writing a message into the one or more frames of the video further includes converting the one or more frames from the frequency domain to the spatial domain. The method may provide for hiding a message in an image while maintaining image appearance.

In some embodiments, each packetized message segment includes a message segment of the message and one or more fields indicating one or more of: that the message segment is last message segment of the message; an identifier (ID) of the message segment, wherein the ID indicates a position of the message segment within the message; and a length of the message segment, the length measured in chunks. The method may provide for transmitting a large hidden message, where large refers to a message that cannot be transmitted in a single image (or frame).

In some embodiments, the one or more templates is based on a pre-configuration set of templates comprising the one or more templates. The method may provide for an automated aligning of captured image to correct perspective distortions.

According to a second aspect, a second method is provided. The method includes capturing one or more frames of a video displayed on a device, the one or more frames comprising a message that is hidden. The method further includes locating one or more templates in the captured one or more frames. The method further includes correcting frame perspective of the captured one or more frames based on the located one or more templates. The method further includes extracting the message from the one or more frames of the video. The method may further provide for automated correcting of captured images that have perspective distortions. The method may provide for retrieving a hidden message.

In some embodiments of the second aspect, the message comprises a plurality of message segments. In some embodiments, each message segment of the plurality of message segments is packetized with control information. In some embodiments, the extracting the message includes extracting, from a plurality of frames of the video, the plurality of message segments and control information associated with each message segment. The method may provide for retrieving a large hidden message, where large refers to a message that cannot be hidden in one image or frame.

In some embodiments of the second aspect, the one or more templates is based on a pre-configuration set of templates comprising the one or more templates.

In some embodiments of the second aspect, the method further includes reordering the plurality of message segments according to the control information. In some embodiments of the second aspect, the control information indicates that the extracted message segment is last message segment of the hidden message. In some embodiments, the control information indicates an identifier (ID) of the associated message segment. In some embodiments of the second aspect, the control information indicates a length of the associated message segment, the length measured in chunks. The method provides for retrieving the full message that is hidden in a plurality of frames.

In some embodiments of the second aspect, the extracting the message from the one or more frames includes converting the one or more frames from spatial domain to frequency domain. In some embodiments, the extracting the message from the one or more frames further includes de-modulating one or more frequency components of the frequency domain used to carry the message. In some embodiments, the extracting of the message from the one or more frames further includes extracting the message from the de-modulated one or more frequency components of the frequency domain of the one or more frames. The method may provide for retrieving a hidden message.

According to a third aspect, an apparatus is provided, where the apparatus includes modules configured to perform the above-mentioned methods, according to the different aspects described herein.

According to a fourth aspect, an apparatus is provided, where the apparatus includes: a memory, configured to store a program; a processor, configured to execute the program stored in the memory, and when the program stored in the memory is executed, the processor is configured to perform the methods in the different aspects described herein.

According to a fifth aspect, a computer readable medium is provided, where the computer readable medium stores program code executed by a device, and the program code is used to perform the methods the different aspects described herein.

According to a sixth aspect, a chip is provided, where the chip includes a processor and a data interface, and the processor reads, by using the data interface, an instruction stored in a memory, to perform the different aspects described herein.

Other aspects of the disclosure provide for apparatus, and systems configured to implement the methods according to the different aspects disclosed herein. For example, an electronic device can be configured with machine readable memory containing instructions, which when executed by the processors of these devices, configures the device to perform the methods disclosed herein.

Embodiments have been described above in conjunction with aspects of the present disclosure upon which they can be implemented. Those skilled in the art will appreciate that embodiments may be implemented in conjunction with the aspect with which they are described but may also be implemented with other embodiments of that aspect. When embodiments are mutually exclusive, or are incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present disclosure will become apparent from the following detailed description, taken in combination with the appended drawings, in which:

FIG. 1 illustrates a concept of screen-camera capture communication, according to an embodiment of the present disclosure.

FIG. 2 illustrates an embedding procedure, according to an embodiment of the present disclosure.

FIG. 3 illustrates an extracting procedure, according to an embodiment of the present disclosure.

FIG. 4 illustrates a frequency-based digital watermarking according to an embodiment of the present disclosure.

FIG. 5 illustrates marker identification or insertion, according to an embodiment of the present disclosure.

FIG. 6 illustrates marker example in a video, according to an embodiment of the present disclosure.

FIG. 7 illustrates a perspective correction operation, according to an embodiment of the present disclosure.

FIG. 8 illustrates a bespoke protocol for message segmentation and sequencing, according to an embodiment of the present disclosure.

FIG. 9 is a schematic diagram of an electronic device that may perform any or all of operations of the above methods and features explicitly or implicitly described herein, according to different embodiments of the present disclosure.

It will be noted that throughout the appended drawings, like features are identified by like reference numerals.

### DETAILED DESCRIPTION

The so-called “screen-capture” problem involves two devices communicating via screen and camera: while one device displays (i.e., transmits) information on its screen, the other captures (i.e., receives) information using its camera. Screen capture can be implemented in various ways, including but not limited to optical character recognition (OCR), barcodes, and more recently quick response (QR) codes. OCR is described in Nagy, George, Thomas A. Nartker, and Stephen V. Rice, “Optical character recognition: An illustrated guide to the frontier”, Document Recognition and Retrieval VII. Vol. 3967, International Society for Optics and Photonics, 1999. QR codes is described in ISO/IEC 18004:2000, Information technology-Automatic identification and data capture techniques-Bar code Symbology-QR Code, 2000. In the case of QR codes, a square region with black and white markings must be visible on screen for the technique to function. From the user's point of view, however, such an approach can be an obtrusive presence and therefore may not be suitable in all products, especially when the visual appeal of a product is highly valued. A digital watermark embedded in the frequency domain of an image (or video frame) may solve the problem of hiding a message from a user, but two more problems still exist: 1) coping with message sizes greater than the watermark capacity available in a single frame; and 2) correcting perspective distortion of captured frames when the camera is misaligned with the display screen. Digital watermark is described in Cox, Ingemar J., et al., “Secure spread spectrum watermarking for multimedia”, IEEE transactions on image processing 6.12 (1997): 1673-1687.

Embodiments described herein may enable one computing device to send a message from its display screen to the camera of another computing device such that transmission of the message is invisible to the human eye.

As may be appreciated by a person skilled in the art, digital image watermarking can hide additional information (e.g., a binary string) in the frequency domain of a digital image (or video frame). Adding an invisible message to a digital image may typically involve converting the image from the spatial domain to the frequency domain, then, applying a modulation algorithm to selected frequency components that inserts the message. Accordingly, when the image is converted back to the spatial domain, the image should not have any visible evidence of changes and thus would be considered watermarked.

The hidden message in the watermarked image can then be retrieved anytime by converting the image to the frequency domain and applying a demodulation algorithm on the same frequency components used to insert the message. Theoretically speaking, a digital camera can make a copy of the watermarked image by photographing (or recoding) the image while it is displayed on a computer screen. Practically speaking, unless the camera is perfectly aligned with the screen, such that it captures only the area of the screen displaying the watermarked image—while maintaining the same resolution and without causing any perspective distortions—retrieving the hidden message by, for example, applying the inverse method used to insert it, is challenging and may be impractical. Moreover, the resolution of a digital image (or video frame), the watermarking algorithm, and the display screen that presents that image are all limiting factors when it comes to transmission capacity (i.e., the amount of information that can be communicated). If more information needs to be sent than is available for transmission, the message may be truncated. While the message could be segmented and transmitted over a series of images (or video frames) in a loop, reordering the captured segments when the display and camera are out of sync (e.g., when the refresh rate of the display is different from the capture rate of the camera) may pose further challenges.

Embodiment described herein may address the following limitations: obtrusive communication via screen-capture, perspective distortion caused by imperfect alignment while capturing an image (or video frame) from a display screen with a digital camera, and out of order message segments received when display and camera are out of sync.

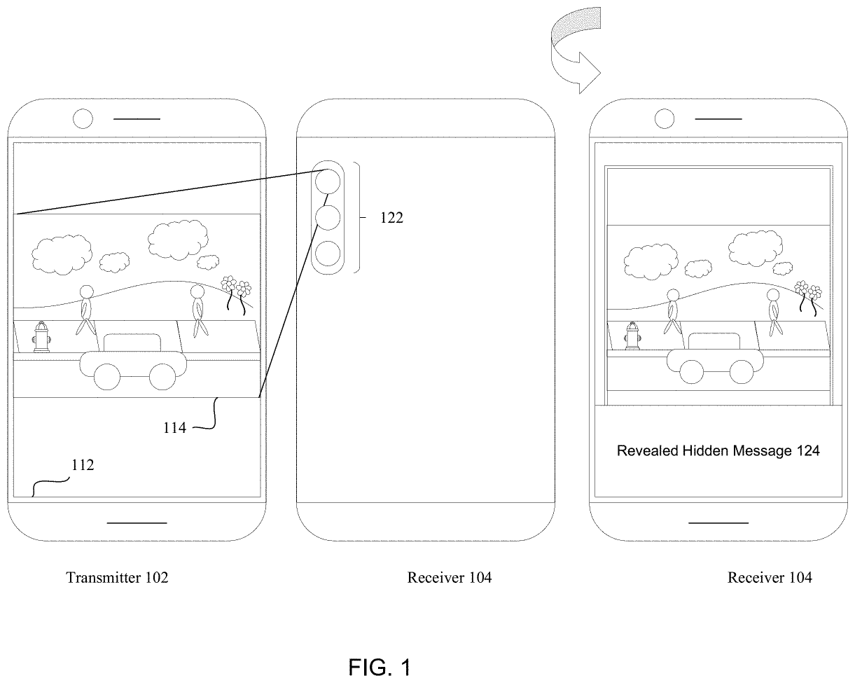

FIG. 1 illustrates a concept of screen-camera capture communication, according to an embodiment of the present disclosure. In an embodiment, a transmitting device or transmitter 102 displays a video 114 on its screen 112, the video 114 indicating both moving and stationary objects. The video 114 may include one or more frames encoded with a hidden message (i.e., invisible to the human eye). A receiving device 104 records the video 114 with its camera 122 and decodes the hidden message 124.

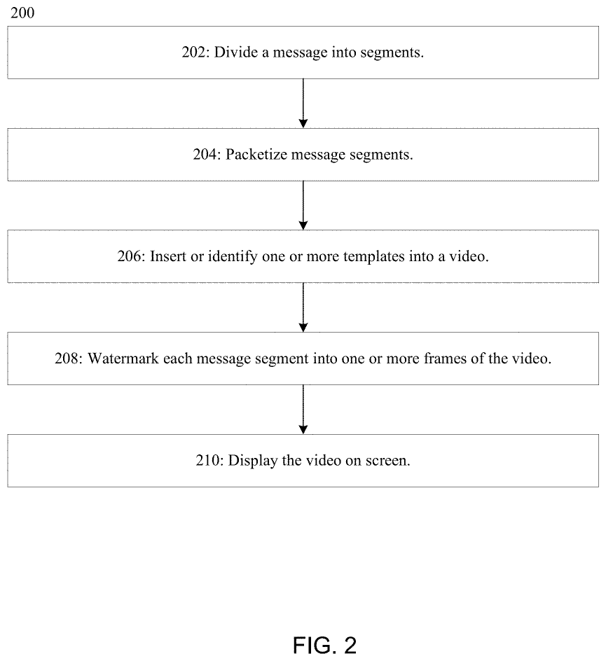

FIG. 2 illustrates an embedding procedure, according to an embodiment of the present disclosure. One or more operations of the embedding procedure 200 may be performed by a transmitter, e.g., transmitter 102. At 202, the transmitter 102 may divide a message, to be communicated to the receiver 104, into two or more message segments. Typically, operations 202 may be performed when the message is too large to be encoded in one frame (from a visibility perspective), accordingly, the message may be divided into segments. In some embodiments, the message may not need to be divided into segments, for example, if the message may be encoded in one frame of a video. In some embodiments, at 204, the transmitter may packetize the message (in the case the message can be encoded in one frame) or one or more message segments by adding control information for each message segment as further described herein. At 206, one or more templates or markers may be identified or inserted in each frame of a video, e.g., video 114. At 208, the transmitter 102 embeds the one or more message segments into frames of the templated video. In the case of one message segment, each frame of the video may be embedded with the single message segment. In the case of two or more message segments, the message segments are sequenced, as indicated by control information, and embedded in the video frames. For example, in the case of two message segments, the message segments may be sequenced as a first and a second message segment, and each consecutive two frames of the video may reflect the first and the second message segments respectively.

In some embodiment, in the case of two or more message segments, each message segment can be embedded in n consecutive frames. For example, in a case of two message segments (first message segment may be indicated by ‘1’, and the second message segment may be indicated by ‘2’), where n is 4, the order of embedding the two message segments may be as follows: 1, 1, 1, 1, 2, 2, 2, 2, 1, 1, . . . The order in which the message segments are embedded does not matter because control information can be used to reorder and detect duplicate segments. Thus, the message segments may be embedded in any order, and using control information, the message segments can be reordered to retrieve the full message.

At 210, the transmitter 102 may display the video 114, via for example looping the video, on its screen 112.

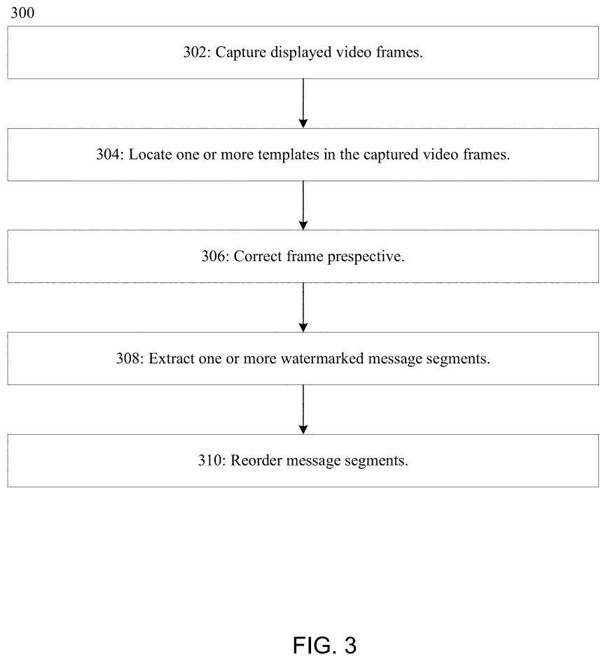

FIG. 3 illustrates an extracting procedure, according to an embodiment of the present disclosure. One or more operations of the extracting procedure 300 may be performed by a receiver, e.g., receiver 104. At 302, the receiver 104 can capture the displayed video via, for example, a camera 122. At 304, the receiver 104 may locate one or more templates in the captured video frames. In some embodiments, at 306, the receiver 104 may correct the frame perspective. The receiver 104 may correct the frame perspective using the inserted or identified one or more templates. At 308, the receiver 104 can extract the one or more message segments from the captured video frames. In some embodiments, in the case of two or more message segments, when the extracted the message segments, the receiver 104, at 310, may reorder the message segments using the control information for retrieval the full message.

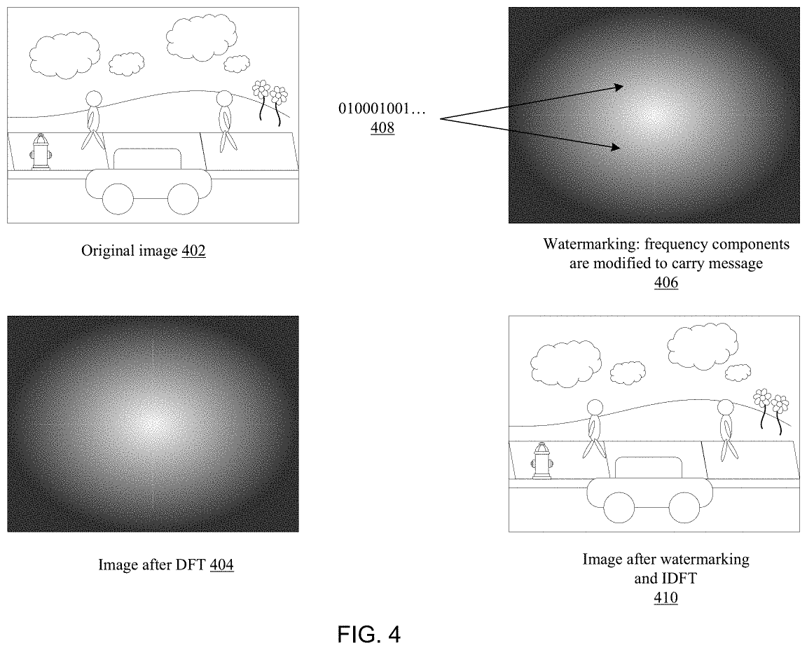

FIG. 4 illustrates a frequency-based digital watermarking according to an embodiment of the present disclosure. In an embodiment, a digital image 402 (i.e., the message carrier) may be converted from spatial domain (e.g., image 402) representation to frequency domain (e.g., image 404) using a discrete Fourier transform (DFT). DFT is described in Smith, Steven W. The scientist and engineer's guide to digital signal processing. Vol. 14. San Diego: Calif. Technical Pub., 1997. The digital image after DFT 404 is illustrated for example in FIG. 4.

As may be appreciated by a person skilled in the art, invisible watermarking may allow a message to be hidden from human eyes. A message, (e.g., a group of English words or sentences) may be converted into a bit stream 408 (i.e., a series of ones and zeros as illustrated). The bit stream 408 may be encoded with an error correction code (ECC) (e.g., Reed-Solomon codes) in an attempt to overcome bit flipping (i.e., errors) during message transmission. Reed-Solomon codes is described in Reed, Irving S., and Gustave Solomon. “Polynomial codes over certain finite fields.” Journal of the society for industrial and applied mathematics 8.2 (1960): 300-304.

Each bit of the encoded message may then be modulated into selected frequency components of the image (the image being in the frequency domain), using, for example, a watermarking technique. Watermarking techniques are described in, for example, Pereira, Shelby, and Thierry Pun. “Fast robust template matching for affine resistant image watermarks.” International Workshop on Information Hiding. Springer, Berlin, Heidelberg, 1999. The modified image in the frequency domain 406 is illustrated in FIG. 4 wherein frequency components are modified to carry the message. Thereafter, an inverse Discrete Fourier transform (IDFT) may be applied to the modified frequency domain, to obtain the image in the spatial domain, which although includes the message, the resulting image appears to be unchanged, e.g., image after watermarking and IDFT 410.

Accordingly, in an embodiment, the watermarking procedure may involve operations including one or more of: converting a message into a bit stream, applying error correction code and the like to the bit stream, selecting, from the frequency domain of the image (after having converted the image from its spatial domain to its frequency domain), frequency components for modulating the bit stream, modulating the selected frequency components to encode the bit stream by changing the corresponding frequency values, and converting the image from its frequency domain back to its spatial domain.

Embodiments described in reference to FIG. 4 may refer to the watermarking operation, 208, of the procedure 200. Embodiment described herein may provide for transmission of a message hidden from human eyes. Embodiments may provide for transmitting a message via a visually stimulating image (e.g., a natural landscape or a scenic view), rather than a blocky artificial depiction of a QR code.

Embodiments described herein may provide for correcting perspective distortion via template matching. Perspective distortion may result from imperfect (e.g., imperfect angle) capturing, by a receiver for example, of a watermarked image or video frame. For example, while capturing a watermarked image or video frames from a screen, a user is less likely to hold the receiving device steady, resulting in camera angles that alter the perspective of the displayed image.

As may be appreciated by a person skilled in the art, to extract a watermarked message from the received image or video frame, the perspective must be corrected and the resolution adjusted to the size of the image before watermarking. Template matching techniques may be used to correct a perspective distortion. Template matching may refer to digital image processing techniques for finding known objects (templates) in an image. Template matching may be template-based or feature-based. Other template matching techniques may be known by a person skilled in the art.

As may be appreciated by a person skilled in the art, the template-based approach for template matching involves sliding a template (or patch) over the captured image and calculating similarities in the process where cross-correlation and a sum of absolute difference applied. Template-based approaches involves comparing the template image against the captured image via sliding. The template image is moved one pixel at a time, for example, from left to right or from top to bottom, to enable calculating some numerical measure of similarity. Both the template image and the captured image can be converted into binary images or in black and white and then template matching techniques, such as, normalized cross-correlation, cross-correlation, and sum of squared difference, can be applied.

Alternatively, the feature-based approach for template matching works by automatically detecting interest points on the template and the query image, the image in which we are trying to find the template. These interest points may be distinctive points, edges, and corners that are stable under different image perturbations and transformation. Next, a visual descriptor may be used to encode information such as gradient orientations in the local neighborhood of these interest points. These descriptors act as fingerprints that distinguish the features from each other. Thereafter, a matching algorithm may be used to find correspondence between similar descriptors in the template and the query image. The query image can refer to the captured image or video frame. Deep learning approaches may also be used to pinpoint similarities in shapes, textures, and colors.

Once the location of these templates is found in the captured image, a homography matrix may be computed and applied to a perspective warping function that aligns the captured image with a base image. As may be appreciated by a person skilled in the art, the homography matrix can be applied to both template matching approaches (e.g., the template-based approach and the feature-based approach). Homograpahy matrix is described in, for example, Baer, Reinhold. Linear algebra and projective geometry. Courier Corporation, 2005. As may be appreciated by a person skilled in the art, without aligning the captured image with respect to its base image, successfully extracting a watermarked message can be challenging. The aligning operation may be performed automatically, according to embodiments described herein.

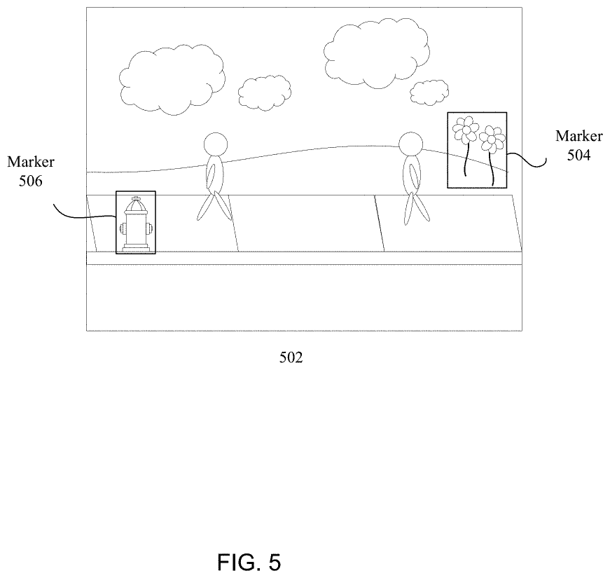

FIG. 5 illustrates marker identification or insertion, according to an embodiment of the present disclosure. Before watermarking, the image (or video) is analyzed to identify potential markers (i.e., templates) for use in the perspective correction process at the receiver. In some embodiments, markers may be added if none already exists. For example, in image 502, the fire hydrant, marker 506, and flowers, marker 504, can be added to the image. The fire hydrant, marker 506, and flowers, marker 504 may then be used for correcting perspective distortion at the receiver side.

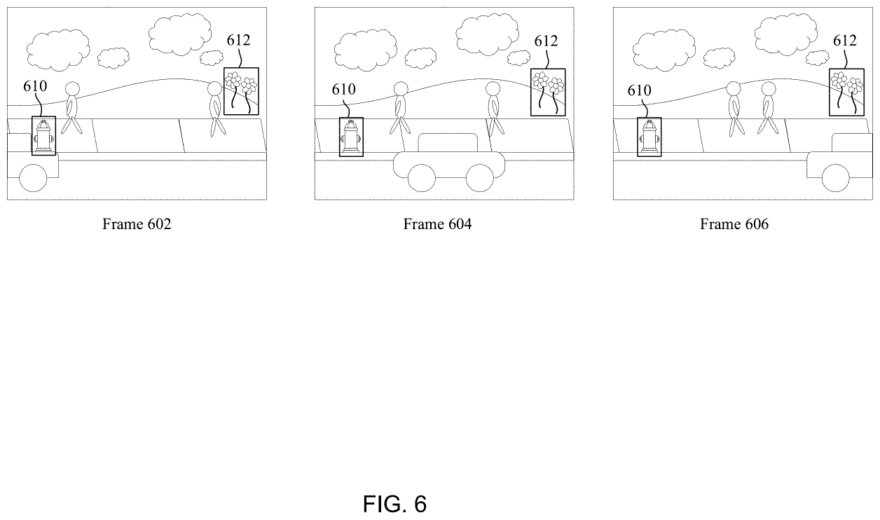

In the case of a video, markers must be fixed in size and location over several frames, as illustrated, for example, in FIG. 6. In some embodiments, from the end-user perspective, these markers can be added in as many video frames as needed so that the background is consistent across these frames.

FIG. 6 illustrates marker example in a video, according to an embodiment of the present disclosure. One or more markers in a video may be identified in the image or inserted (if none exists), provided the one or more markers are fixed in size and location. In a video comprising frames 602, 604, 606, markers may include markers 610 and 612. In some embodiments, one or more markers 610 and 612 may be identified in the video or inserted. As illustrated, markers 610 and 612 identified or inserted for template matching are seen as fixed objects over multiple frames.

Embodiments described in reference to FIG. 5 and FIG. 6 and in reference to identifying or inserting templates into an image or video frames may refer to operation 206 of the procedure 200 (i.e., inserting or identifying one or more templates in a video).

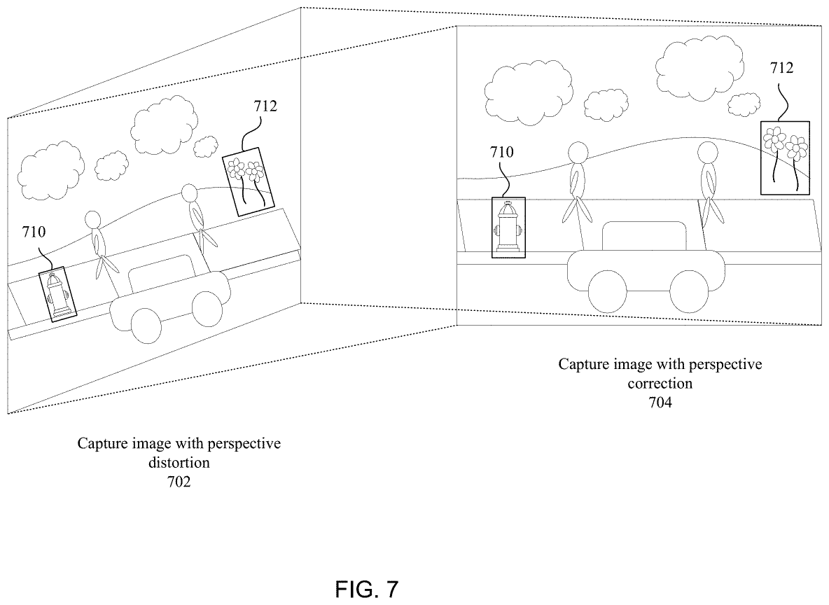

FIG. 7 illustrates a perspective correction operation, according to an embodiment of the present disclosure. As described herein, a receiver may capture an image or a video frame such that the captured image or video has a perspective distortion, as illustrated for example in the captured image 702. The receiver may perform template matching based on one or more fixed markers (e.g., markers 710 and 712) to obtain a captured image with perspective correction 704 as illustrated. Template matching are described in embodiments herein.

Based on the correspondence between a captured image (e.g., image 702) that has perspective distortion and the base image having a canonical view (not having perspective distortion), the receiver may align or transform the captured image to the base image. The receiver may be preconfigured with knowledge of the one or more markers (e.g., markers 710 and 712) and their corresponding locations for template matching functionalities. Accordingly, in some embodiments, the receiver and the transmitter may be preconfigured with the set of one or more templates that may be used for correcting the perspective distortion. As illustrated, the captured image is restored to its correct perspective (or viewing angle), image 704.

Other template matching techniques may be applied to correct the perspective distortion as may be appreciated by a person skilled in the art. Embodiments described in reference to FIGS. 5, 6 and 7 and in reference to correcting perspective distortions may refer to operation 306 of the procedure 300.

Embodiments described herein may provide for correcting a perspective distortion in a captured image or video frame. Embodiments described herein may further provide for an automated method to realign captured images to their correct perspective. As may be appreciated by a person skilled in the art, watermark extraction may require the received image or video frame to be aligned with respect to the orientation and viewing angle of the original image, i.e., before watermarking. Accordingly, in some embodiments, retrieval of the transmitted message may be dependent on adequate perspective correction technique.

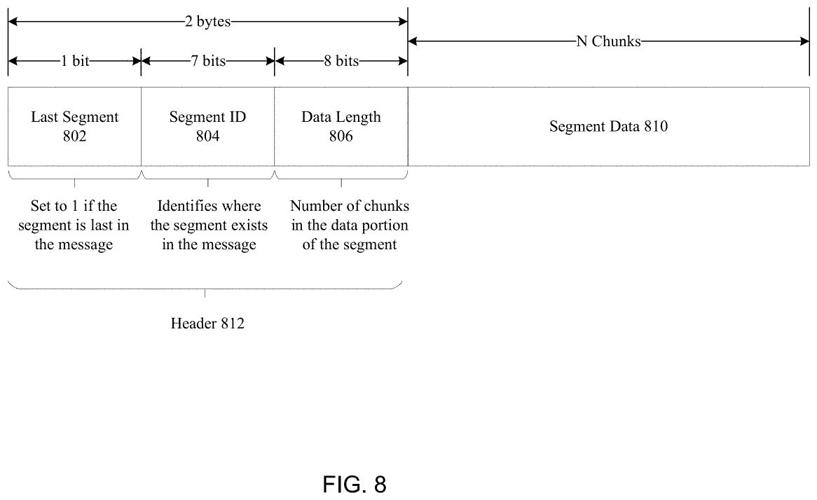

Embodiments described herein may provide for message segmentation and sequencing. In some embodiments, a message, intended to be transmitted, may be too large to be carried in a single frame. In such embodiments, the message may be broken up into parts (called segments) and transmitted in a video over multiple frames. However, transmitting a plurality of message segments without additional control information in each message segment, can render the receiver unable to: determine the correct order of the transmitted message segments, and determine that all message segments have been received. Accordingly, embodiments described herein may provide for a bespoke protocol, as illustrated in FIG. 8, that may be used to add control information to each message segment. The added control information may be in a form of a header, for example. The control information may provide for determining the correct order of the transmitted message segments. The control information may further provide for determining that all message segments have been received.

FIG. 8 illustrates a bespoke protocol for message segmentation and sequencing, according to an embodiment of the present disclosure. The illustration in FIG. 8 may be a representation of the bit stream 408 that is embedded or written via modulation in the frequency domain of the image or frame. Further, operation 204 of the procedure 200 may refer to the bespoke protocol of FIG. 8 that may be used for packetizing the message segment.

In an embodiment, the header 812 may be 2 bytes long and comprise one or more of: a first field 802 indicating that the message segment is the last segment, a second field 804 indicating an identifier (ID) of the segment, and a third field 806 indicating a data length of the segment.

In an embodiment, the first field 802 may be a 1-bit flag to inform the receiver when it has received the last segment. In an embodiment, the second field 804 may be 7-bit long and indicate the segment ID for a maximum of 128 segments per message. Segment IDs may start at 0 and be sequential in order. Accordingly, when a message segment arrives at the receiver and has the first field set to 1 (i.e., indicating the segment is the last segment in the message), the receiver may determine the total number of segments that have been transmitted based on the segment's ID. In general, the receiver may determine the total number of message segments based on the first field 802 (i.e., last segment) and the second field 804 (i.e., segment ID). Moreover, any segments that were missed can be recaptured as long as the transmitter continues to run the video in a loop.

In an embodiment, the third field 806 may be 8-bit long and indicate the length of the segment (i.e., the length of the segment data 810 excluding the header 812). In some embodiments, the length of the segment may be measured in chunks, wherein the value of a chunk in bytes may be implementation specific. Using chunks as the measure of length of the segment may provide flexibility for transmission of larger messages. For example, if a chunk is equal to 1 byte, then the maximum length of a segment may be 256 bytes with a maximum message size of 32768 bytes (or 32.768 KB). Similarly, if a chunk is equal to 1 kilobyte, then the maximum length of a segment may be 256000 bytes (or 256 KB) with a maximum message size of 32768000 bytes (or 32.768 MB).

An example of message embedding may be as follows. A message may comprise 5 segments to be embedded or written in a video comprising 30 frames. Each consecutive set of five frames may be encoded with the 5 message segments, each segment being encoded in a respective different frame of each set of five frames. Accordingly, all 30 frames may be encoded with message segments, wherein each consecutive set of five frames may be encoded with the same 5 message segments, such that when the video is displayed, the message segment (i.e., the 5 message segments) are transmitted, continuously in a loop. Accordingly, a receiver capturing the video, after performing the perspective correction procedure, may extract the one or more message segments from the video and reorder the message segments based on the control information accompanying the message segments.

As described herein, embedding or writing a message segment in an image or a video frame may be as follows. The image or video frame may be converted from its spatial domain to its frequency domain. The message segment may be embedded or written in the frequency domain of the image or video frame. The image is then converted back from its frequency domain to spatial domain. The embedding or writing the message segment into the frequency domain may involve selecting, from the frequency domain, frequency components for modulation, and thereafter, modulating the selected frequency components to embed or write the message segment.

The extracting procedure may be reverse of the embedding procedure. For example, a captured image may be converted to its frequency domain. From the frequency domain, the entire packetized message segment (including the message segment and control information) may be extracted. Using the control information in the header 812, the order of the message segments and the total number of message segments (i.e., the entire message) may then be determined.

Embodiments described herein, including embodiments described reference to FIG. 8, may provide for transmission of larger messages (e.g., messages that may be too large to be transmitted in an image or a frame). Embodiments described herein may provide for segment ordering mechanisms (e.g., via control information accompanied with each message segment) at the receiver, where segments may be corrected order according to their transmission without relying on feedback from the transmitter.

Embodiments described herein may provide for using a frequency-based invisible image watermarking technique as a means to hide visually obtrusive message artifacts to communicate information between a computer screen and a digital camera. Frequency-based invisible watermarking can hide a message in plain view (i.e., inside a digital image). A message can be encoded into frames of a video or animation, thereby providing a communication process that is visually pleasing.

Embodiments described herein may further provide for automatic perspective correction procedures post image capture via applying template matching techniques. Accordingly captured images or frames may be automatically realigned to correct perspective using, for example, template matching. While perspective correction procedure embodiments have been described in reference to techniques, for example, based on inserting one or more templates into an image or a frame, perspective correction procedures may be performed via aligning a captured image with the shape of a digital display's bezel (e.g., the unique bezel on a watch).

Embodiments described herein may further provide for correct sequencing and proper message retrieval (i.e., reordering) upon reception via a bespoke protocol for segmenting messages before transmission. Accordingly, messages too large to be transmitted in a single frame can be broken up and sent across multiple frames. Embodiments may provide for transmission of large messages or increased message capacity. The transmitted segmented messages may be reordered at the receiver without acknowledgement from the transmitter. Further, embodiments described herein may obviate the need for synchronization between the sender and receiver (e.g., video can start playing at any time).

Embodiments described herein may have various application as may be appreciated by a person skilled in the art. Embodiments described herein may be used, for example, to pair a smart phone with a smart watch out-of-the-box (OTB). Following the unboxing of a new smart watch, a user may wish to establish a permanent (and secure) communication channel between the watch and their phone. To initiate the pairing process, however, the phone may need to be configured with unique information related to the new watch. To enhance the configuration process in terms of convenience and visual appeal (e.g., style), a video may be played on the watch (e.g., the transmitter) with an invisible message containing the necessary configuration details. The phone (e.g., the receiver) may then receive the configuration details as the user positions their phone's camera in view of the watch's display, capturing the video while it plays on the watch's screen. Applications to which embodiments described herein may be used for are not limited to the smart watch scenario, as there are many other devices that could also benefit from establishing ephemeral communication channels, such as televisions and in-car infotainment systems.

Embodiments described herein may further apply to interactive customer engagements with live advertisements through digital billboards, screens in shopping malls, or at home during television broadcasts. For example, a customer may be attracted to an advertising screen displaying a flash sale to new customers that sign-up for a loyalty program. Upon approaching the screen, a customer or a user might be able to expedite the sign-up process by simply facing the camera on their phones to the pictures displayed on screen. Other applications of the embodiments described herein may be known by persons skilled in the art.

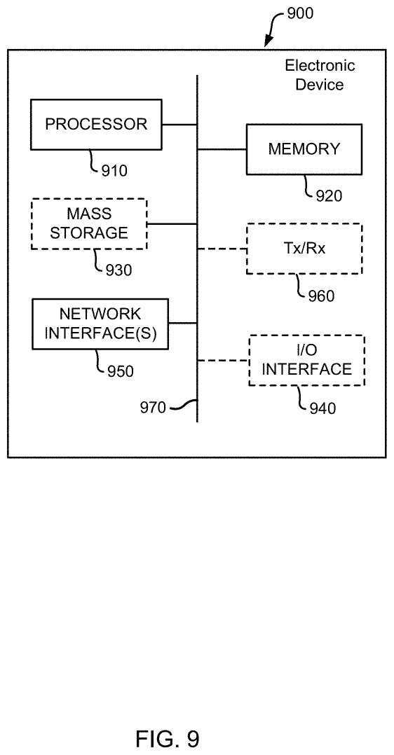

FIG. 9 is a schematic diagram of an electronic device 900 that may perform any or all of operations of the above methods and features explicitly or implicitly described herein, according to different embodiments of the present disclosure. For example, a computer equipped with network function may be configured as electronic device 900. In some embodiments, the electronic device 900 may be a user equipment (UE), a transmitter or a receiver as appreciated by a person skilled in the art. UE may refer to a wireless mobile device for example.

As shown, the electronic device 900 may include a processor 910, such as a Central Processing Unit (CPU) or specialized processors such as a Graphics Processing Unit (GPU) or other such processor unit, memory 920, non-transitory mass storage 930, input-output interface 940, network interface 950, and a transceiver 960, all of which are communicatively coupled via bi-directional bus 970. Input-output interface 940 can comprise a mechanism for capturing an image or a video (e.g., a camera). Input-output interface 940 can further comprise a mechanism for communicating an image or a video (e.g., a display).

According to certain embodiments, any or all of the depicted elements may be utilized, or only a subset of the elements. Further, electronic device 900 may contain multiple instances of certain elements, such as multiple processors, memories, or transceivers. Also, elements of the hardware device may be directly coupled to other elements without the bi-directional bus. Additionally, or alternatively to a processor and memory, other electronics, such as integrated circuits, may be employed for performing the required logical operations.

The memory 920 may include any type of non-transitory memory such as static random access memory (SRAM), dynamic random access memory (DRAM), synchronous DRAM (SDRAM), read-only memory (ROM), any combination of such, or the like. The mass storage element 930 may include any type of non-transitory storage device, such as a solid state drive, hard disk drive, a magnetic disk drive, an optical disk drive, USB drive, or any computer program product configured to store data and machine executable program code. According to certain embodiments, the memory 920 or mass storage 930 may have recorded thereon statements and instructions executable by the processor 910 for performing any of the aforementioned method operations described above.

Embodiments of the present disclosure can be implemented using electronics hardware, software, or a combination thereof. In some embodiments, the disclosure is implemented by one or multiple computer processors executing program instructions stored in memory. In some embodiments, the disclosure is implemented partially or fully in hardware, for example using one or more field programmable gate arrays (FPGAs) or application specific integrated circuits (ASICs) to rapidly perform processing operations.

It will be appreciated that, although specific embodiments of the technology have been described herein for purposes of illustration, various modifications may be made without departing from the scope of the technology. The specification and drawings are, accordingly, to be regarded simply as an illustration of the disclosure, and are contemplated to cover any and all modifications, variations, combinations or equivalents that fall within the scope of the present disclosure. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

According to an aspect of the disclosure, a method is provided. The method includes, by a first device, inserting one or more templates into one or more frames of a video. The method further includes, by the first device, writing a message into the one or more frames of the video. The method further includes, by the first device, displaying the one or more frames of the video comprising the message that is hidden. The method further includes, by a second device, capturing the displayed one or more frames of the video. The method further includes, by the second device, locating the one or more templates in the captured one or more frames. The method further includes, by the second device, correcting frame perspective of the captured one or more frames based on the located one or more templates. The method further includes, by the second device, extracting the message from the one or more frames of the video. The method may provide for transmitting and retrieving a hidden message between two devices.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present disclosure may be implemented by using hardware only or by using software and a necessary universal hardware platform. Based on such understandings, the technical solution of the present disclosure may be embodied in the form of a software product. The software product may be stored in a non-volatile or non-transitory storage medium, which can be a compact disc read-only memory (CD-ROM), USB flash disk, or a removable hard disk. The software product includes a number of instructions that enable a computer device (personal computer, server, or network device) to execute the methods provided in the embodiments of the present disclosure. For example, such an execution may correspond to a simulation of the logical operations as described herein. The software product may additionally or alternatively include a number of instructions that enable a computer device to execute operations for configuring or programming a digital logic apparatus in accordance with embodiments of the present disclosure.

Although the present disclosure has been described with reference to specific features and embodiments thereof, it is evident that various modifications and combinations can be made thereto without departing from the disclosure. The specification and drawings are, accordingly, to be regarded simply as an illustration of the disclosure, and are contemplated to cover any and all modifications, variations, combinations or equivalents that fall within the scope of the present disclosure.

1. A method comprising:
inserting one or more templates into one or more frames of a video for correcting frame perspective of the one or more frames captured by a device;
writing a message into the one or more frames of the video; and
displaying the video comprising the message that is hidden.

2. The method of claim 1 further comprising:
dividing the message into a plurality of message segments; and
packetizing each message segment with control information.

3. The method of claim 2, wherein the writing a message into the one or more frames of the video comprises:
writing each packetized message segment into a different respective frame of the video.

4. The method of claim 3, wherein the writing each packetized message segment into a different respective frame of the video comprises:
converting each frame of the video from spatial domain to frequency domain;
writing each packetized message segment into the frequency domain of a different respective frame of the video; and
converting each frame of the video from the frequency domain back to the spatial domain.

5. The method of claim 4, wherein the writing each packetized message segment into the frequency domain of a different respective frame of the video comprises:
selecting, from the frequency domain, frequency components for modulations; and
modulating the selected frequency components to write in the frequency domain the said packetized message segment.

6. The method of claim 1, wherein the writing a message into the one or more frames of the video comprises:
converting the one or more frames from spatial domain to frequency domain;
writing the message into the frequency domain of each of the one or more frames; and
converting the one or more frames from the frequency domain to the spatial domain.

7. The method of claim 2, wherein each packetized message segment comprises:
a message segment of the message; and
one or more fields indicating one or more of:
that the message segment is last message segment of the message;
an identifier (ID) of the message segment, wherein the ID indicates a position of the message segment within the message; and
a length of the message segment, the length measured in chunks.

8. The method of claim 1, wherein the one or more templates is based on a pre-configuration set of templates comprising the one or more templates.

9. A method comprising:
capturing one or more frames of a video displayed on a device, the one or more frames comprising a message that is hidden;
locating one or more templates in the captured one or more frames;
correcting frame perspective of the captured one or more frames based on the located one or more templates; and
extracting the message from the one or more frames of the video.

10. The method of claim 9, wherein:
the message comprises a plurality of message segments;
each message segment of the plurality of message segments is packetized with control information; and
the extracting the message comprises extracting, from a plurality of frames of the video, the plurality of message segments and the control information associated with each message segment.

11. The method of claim 9, wherein the one or more templates is based on a pre-configuration set of templates comprising the one or more templates.

12. The method of claim 10 further comprises:
reordering the plurality of message segments according to the control information.

13. The method of claim 12, wherein the control information indicates one or more of:
that the extracted message segment is last message segment of the message;
an identifier (ID) of the associated message segment; and
a length of the associated message segment, the length measured in chunks.

14. The method of claim 9, wherein the extracting the message from the one or more frames comprises:
converting the one or more frames from spatial domain to frequency domain;
de-modulating one or more frequency components of the frequency domain used to carry the message; and
extracting the message from the de-modulated one or more frequency components of the frequency domain of the one or more frames.

15. An apparatus comprising:
at least one processor and at least one machine-readable medium storing executable instructions which when executed by the at least one processor configure the apparatus for:
inserting one or more templates into one or more frames of a video to be used for correcting frame perspective of the one or more frames captured by a device;
writing a message into the one or more frames of the video; and
displaying the video comprising the message that is hidden.

16. The apparatus of claim 15, wherein the at least one processor further configure the apparatus for:
dividing the message into a plurality of message segments; and
packetizing each message segment with control information.

17. The apparatus of claim 16, wherein the at least one processor further configure the apparatus for: writing each packetized message segment into a different respective frame of the video.

18. An apparatus comprising:
at least one processor and at least one machine-readable medium storing executable instructions which when executed by the at least one processor configure the apparatus for:
capturing one or more frames of a video displayed on a device, the one or more frames comprising a message that is hidden;
locating one or more templates in the captured one or more frames;
correcting frame perspective of the captured one or more frames based on the located one or more templates; and
extracting the message from the one or more frames of the video.

19. The apparatus of claim 18, wherein
the message comprises a plurality of message segments;
each message segment of the plurality of message segments is packetized with control information; and
the extracting the message comprises extracting, from a plurality of frames of the video, the plurality of message segments and control information associated with each message segment.

20. The apparatus of claim 18, wherein the one or more templates is based on a pre-configuration set of templates comprising the one or more templates.
